(19) United States
(12) Patent Application Publication
(10) Pub. No.: US 2024/0059586 A1
(43) Pub. Date: Feb. 22, 2024

(54) Seawater RO desalination by pneumatic power tapped from offshore ocean wave energy

(71) Applicant: Yona Becher, Budd Lake, NJ (US)

(72) Inventor: Yona Becher, Budd Lake, NJ (US)

(21) Appl. No.: 18/445,224

(22) Filed: Jun. 5, 2023

(51) Int. Cl. C02F 1/26; C02F 1/44

(52) U.S. Cl. CPC C02F 1/265; C02F 1/441; C02F 2307/00; C02F 2103/08

(57) ABSTRACT

Offshore ocean desalination apparatus for 1.5 million GPM/D seawater into drinking water by Reverse Osmosis using renewable energy stored energy of compressed air. Multiple desalination units were installed on the construction tower 50 feet above seawater level, with the tower moored to the ocean floor up to 100 meters deep and equipped with air pressurized tank, and two seawater supply tanks, providing 1000 psig air to the desalination unit's moving actuator, with seawater in container pressurized by said moving actuator to push drinking water through 2 micron RO membrane located in a filter plate. The filter plates with hundreds of filter elements, each of 2-inch diameter, are secured to six vertical walls of the seawater container, to the container bottom, and to the top moving actuator lower side. Seawater a pumped from 20 feet below seawater level using an Archimedes screw-type pump powered by a supersonic air turbine.

### BACKGROUND OF THE INVENTION

Water has meant life for many human communities for thousands of years. The price of high-quality drinking water affects the quality of life and the daily cost of food, including vegetable and animal-origin products. During the thousands of years of human history, the lack of adequate drinking water around the world, including deserts and islands surrounded by hundreds of miles-long coasts alongside large oceans, had a significant effect on the development of cities and towns around the world and their sustainability during long periods of droughts. Drought is an extended period of unusually dry weather when there is not enough rain. The lack of precipitation can cause various problems for local communities, including damage to crops and a shortage of drinking water. These effects can lead to devastating economic and social disasters, such as famine, forced migration away from drought-stricken areas, and conflict over remaining resources. The Old Testament Bible tells the story about Ishmael, the son of Ancestor Abraham, who could have died after he ran out of drinking water in the dry desert before he was saved in Southern Israeli Negev, where also there was a war between shepherds of Abraham and his brother on water wells four thousand years ago. Because the full effects of a drought can develop slowly over time, impacts can be underestimated. However, drought can have drastic and long-term effects on vegetation, animals, and people. Since 1900, more than 11 million people have died, and more than 2 billion people have been affected by drought. Drought is also one of the costliest weather-related disasters. Since 2014 California has lost at least 2 billion dollars a year due to drought. Desalination technology using oceans and seas salted water has brought freshwater and industrial and commercial sustainable living conditions for humans and livestock to some cities and towns along oceans shores around the world, leading to the development to dry and rainless areas of the world that otherwise might have remained deserted and unpopulated. In contrast, bad quality water caused significant health problems in remote areas where good quality water was not achievable without major technology and monetary investment.

Reverse Osmosis (RO) desalination technology, since the mid-1960s, has brought freshwater and living conditions to areas of the world and allowed tens of millions of people to settle and build cities in dry deserted areas. Not only has development been enhanced by this technology, but, more importantly, the health and welfare of tens of millions of people have been improved by freshwater supply. Advancements in typical 1-2 micron RO osmotic membrane manufacturing and application engineering have made RO the leading process in the worldwide water desalination market. The definition of desalination generally is considered to be the production of fresh water from seawater. However, the term also is commonly used by engineers to describe the desalting of slightly to moderately saline waters, generally referred to as brackish water. Desalination by RO requires the use of an osmotic membrane, one that allows water to pass through it at much higher rates than dissolved salts. The osmotic membrane also is referred to as a semipermeable membrane because of its capability to allow some constituents to pass through it while holding back others. The Osmosis phenomenon in nature is one where a dilute solution is transported across a semipermeable membrane toward a concentrated solution on the other side. The process of Reverse Osmosis is just the opposite of osmosis. In osmosis, the solvent water passes through the membrane until the pressure difference across the membrane equals the osmotic pressure, approximately 500 PSIG for a freshwater-seawater interface. In the reverse osmosis desalination process, a pressure greater than the osmotic pressure range from 800 to 1000 psig is applied to the saline seawater will cause fresh water to flow through the membrane while holding back the solutes. The higher the applied pressure above the osmotic pressure, the higher the rate of freshwater transports across the membranes.

The main problem with the current state-of-the-art desalination equipment is being too expensive and unaffordable to most communities around the world that needs it desperately to improve the daily life of hundreds of millions of people around the world. The current commercially used osmotic radial osmotic membranes installed in double-walled pipes are the most significant single consumable cost factor in RO desalination and need up to 1000 psi high-pressure water flow through the system. The existing desalination equipment requires expensive pre-treatment of water cleanliness. Increasing membrane cleanliness by filtering the seawater inlet to pump 20-30 feet deep under the seawater level is essential to keep the RO process running efficiently before replacing the membrane sectors. Furthermore, the high water pressure of above 1000 psig in the desalination plant equipment needs high-cost high materials such as high yield-stress strong metallic pipes with limited longevity due to the corrosion of metallic materials. Therefore desalination systems are only partially constructed with plastics and nonferrous components due to the high-pressure stress requirements. Only low-pressure components can be constructed from PVC, fiberglass, or plastics in general. Nevertheless, high-pressure components that require the use of metals must be of an acceptable alloy to their location and application in the system. Seawater environments are highly corrosive, and only the highest material quality is acceptable. The welded high-pressure pipe extended from the offshore ocean to the on-shore plant must have a grade of super austenitic stainless steel. The current state-of-the-art seawater desalination RO system equipment with on-shore plant capital costs ranges from $10/gpd production capacity to $2/gpd capacity for systems ranging from 500 to 1.0 million gallons per day. Water desalination with reverse osmosis has been known since the 1960s, with a typical capacity of 85,000 m3/day Permeate. The energy consumption in desalination is 12 KWh/M3. About 70% of the seawater with high-pressure high-cost energy pumped from the offshore ocean to the onshore plant is wasted, and it is returned to the sea from 60 bar as enriched brine. Therefore lots of energy from high-pressure water flowing back to the ocean is wasted, and only 50% of the waste energy with energy recovery. The membranes used makes up about 30% permeate from the supplied seawater. The energy consumption is very high at 7.8 KWh/M3 permeate. The High-pressure, high-cost pumps with high maintenance cost used must generate a water pressure of 60 to 70 bar. In addition to the high water pressure, pumps and pipes from close-to-shore water pumping locations to onshore plants are also corrosive and exposed to seawater. The membrane itself consists of cellulose acetate spacers made of seawater-resistant plastics. Therefore, the main problem with the current desalination plants is that they are too expensive and are only affordable to rich countries. The form of high current and high voltage electrical energy that runs the large high-pressure pumps that are used in current plants is only accessible to rich countries. It cannot be applied to poor countries along the coast of the ocean and low-populated islands that need drinking water the most. In addition, materials are constantly seawater exposed, requiring highly trained expense personnel for continuous maintenance. The Reverse osmosis current units are costly since they work with a substantial and expensive electrical current that is almost only required for pumping. Intake and pretreatment of the close-to-shore costs can be substantial when considering a surface water source adding anywhere from $0.50 to $2.00 per gallon to the system capital cost where pretreatment costs are predominant. Intake and pretreatment costs for a sound system will add anywhere from $0.20 to $0.80 per gal, where intake costs predominate. Operating costs will predominately vary with varying power costs for the system, as identified earlier. Typical operating costs will range from $2/Kgal of product to $8/Kgal of product for the land-based systems. Remote resort developments have led the way with this technology, but as quality water sources become more and more scarce, both industry and municipalities are recognizing the need for RO desalination. In California, Florida, The Caribbean, Central and South America, the Mediterranean, Middle-East, and the Pacific Rim (i.e., anywhere there's an ocean and a need, RO desalination is a viable resource for the world's freshwater production requirements.

### BRIEF SUMMARY OF THE INVENTION

The main objective of the invention is to bring a new low-cost, affordable means to produce drinkable fresh water from ocean seawater to dry and desert communities around the world located alongside oceans, thereby bringing a better quality of healthier life to humans, and animals in these regions. Another objective of the invention is to provide apparatus that uses renewable clean air energy that is produced offshore ocean by harvesting the natural ocean waves, wind, streams, and tides energy harnessed to hydro-turbine to produce storable energy that is used during the desalination process to achieve drinking water from seawater. A further objective of the invention is to perform the desalination process of seawater using a renewable energy source of compressed air above 1000 psi which is stored in offshore ocean air tanks mounted on construction towers that reach the seabed at depths up to 100 meters.

Another objective of the invention is to build multiple offshore ocean apparatuses along the shores of the American Atlantic, Pacific, and the Gulf of Mexico, with each providing and storing 10 million gallons daily of drinking water.

Another objective of the invention is to provide a desalination process that would store 10 million gallons per day of fresh drinking water from offshore ocean seawater pumped from 20 feet under sea level.

Another objective of the invention is to use U.S. patent application Ser. No. 17/803,601 titled: ‘Pulsed Supersonic air-turbine engine with speed control’ together with a helical screw Achimedes-type pump to deliver good quality clean ocean water to the seawater tanks located 40 feet above sea level, with the air-turbine engines using high-pressure compressed clean renewable energy air from air tanks sourced from the harvesting of ocean waves, winds, streams and tides natural energy.

Another objective of the invention is to use offshore ocean self-produced renewable clean energy converted to high-pressure compressed air for the desalination process thereby providing a 24 hours a day continuous automatic electronically controlled process using the renewable energy hydro-turbine power unit on the offshore ocean based on U.S. patent Ser. No. 11/608,605 by Yona Becher. U.S. patent Ser. No. 11/608,605 titled: ‘Offshore Ocean renewable energy hydro-turbine unit’ installed on a floating platform with towers moored to the ocean floor that harvest the ocean wave, tide, and stream ocean energy to power a high-pressure compressor to store the energy in air tanks mounted on construction towers that are secured to the ocean seabed.

Another objective of the invention is to use 5-micron filtered offshore ocean seawater r with up to 35,000 ppm of total dissolved solids (TDS) pumped from the ocean at a water depth of 20 feet for improved filtered water cleanliness.

A further objective of the invention is to provide a low-cost and affordable to communities around the world desalination apparatus powered by compressed only with no electric power in which the ocean seawater is pressed to 800-1000 PSIG against an osmotic membrane filter of 1-2 micron holes, with only 30% of the salted water passing through the membrane holes, reducing TDS to about 500 ppm which is typical to drink quality water while the other 70% of the ‘raw’ seawater is used to flush the apparatus filter elements and then flowing back to the ocean

A further objective of the invention is to use commercially available osmotic membranes that are made of molded acetate sectors that are attached to supporting membrane-holding devices fixed to sealed filter plates, with self-cleaning filter plates that are disposable and easily replaceable at long time intervals before any maintenance is required.

A further objective of the invention is to use non-corrosive plastic and elastomeric materials for continuous seawater exposure for the desalination apparatus parts to extend the non-maintenance period.

Another objective of the invention is to make the offshore ocean desalination apparatus mounted on bolted tower sections that are mobile and towable by a barge and tugboat. At the same time, they can be assembled in any location and moored using pneumatic means from above seawater level to the ocean floor up to 100 meters deep. Similarly, the desalination apparatus bolted tower sections may be disassembled and towed to another safe location as needed.

### PRIOR ART

1. Patent number DE19647358A1 Titled: Deep seawater reverse osmosis desalination plant which has an outer membrane by Walter Graef published 1998 May 20

A deep seawater desalination plant based on the reverse osmosis principle. The novel features comprise a hollow body that is sunk deep in the sea where water pressure exceeds 800 psig. A reverse osmosis membrane is located externally on the hollow body, where it is exposed to water pressure; (c) atmospheric pressure is maintained in the hollow body by continually pumped removal of the permeate fluid; (d) the differential pressure required to maintain reverse osmosis is already present, and is maintained by evacuation of the permeate; (e) the permeate side of the membrane is linked to the inner chamber by holes and grooves.

### BRIEF DESCRIPTION OF THE DRAWINGS

FIG. 1: Desalination tower and eight desalination apparatus systems

FIG. 2: Desalination tower and eight desalination pumps

FIG. 3: Desalination tower and eight desalination apparatus and pumps

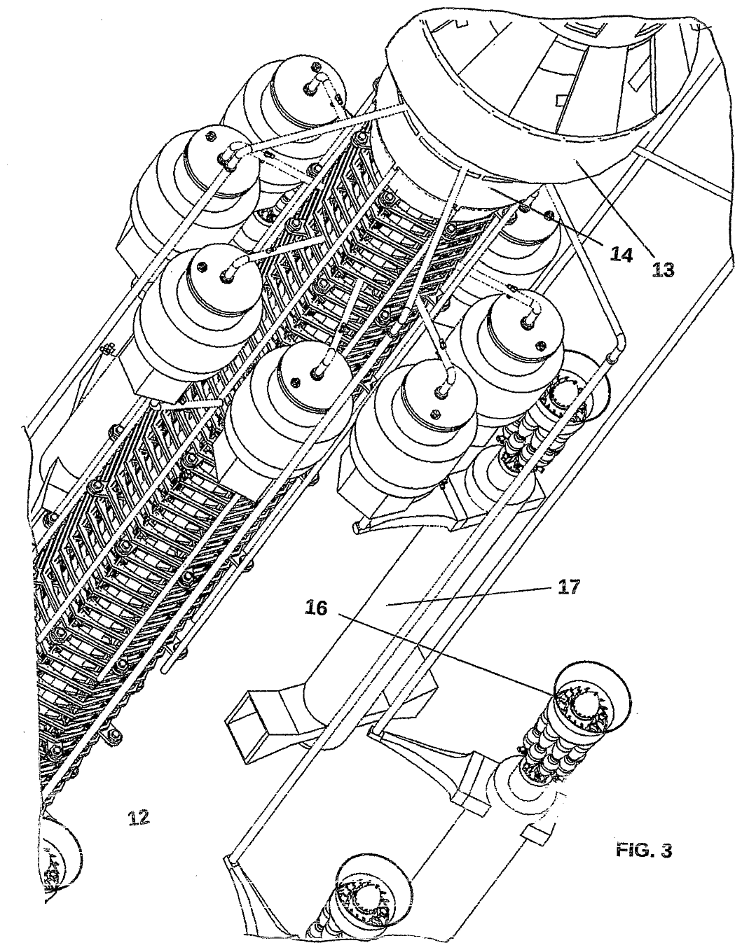

FIG. 4: Desalination tower and eight desalination apparatus and water tanks

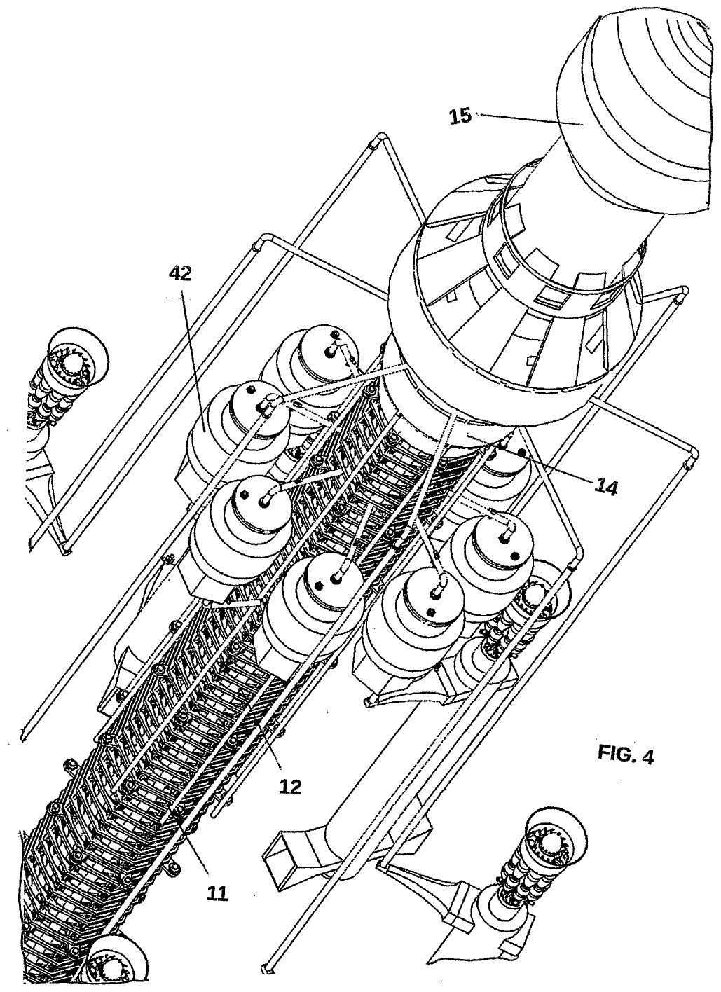

FIG. 5: Desalination tower and eight desalination apparatus and pump engines

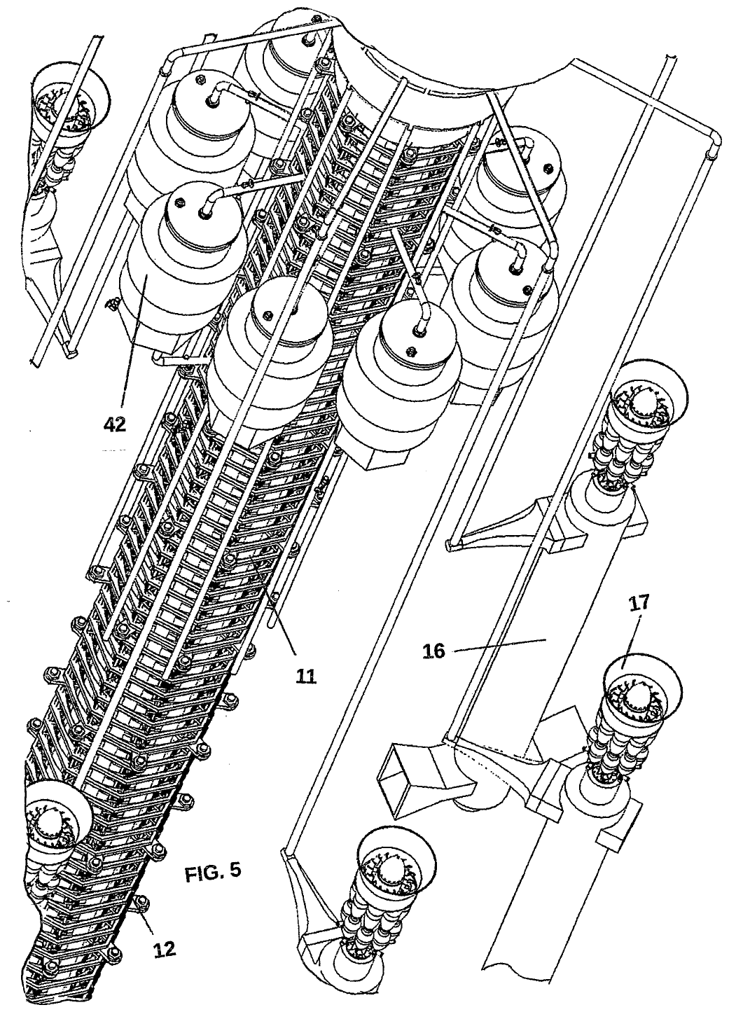

FIG. 6: Archimedes helical screw pump and air-turbine engine

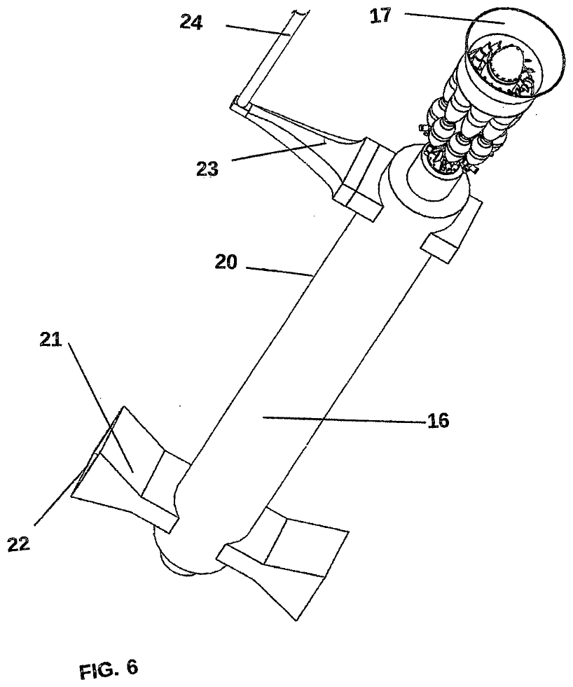

FIG. 7 supply water tank and desalination apparatus

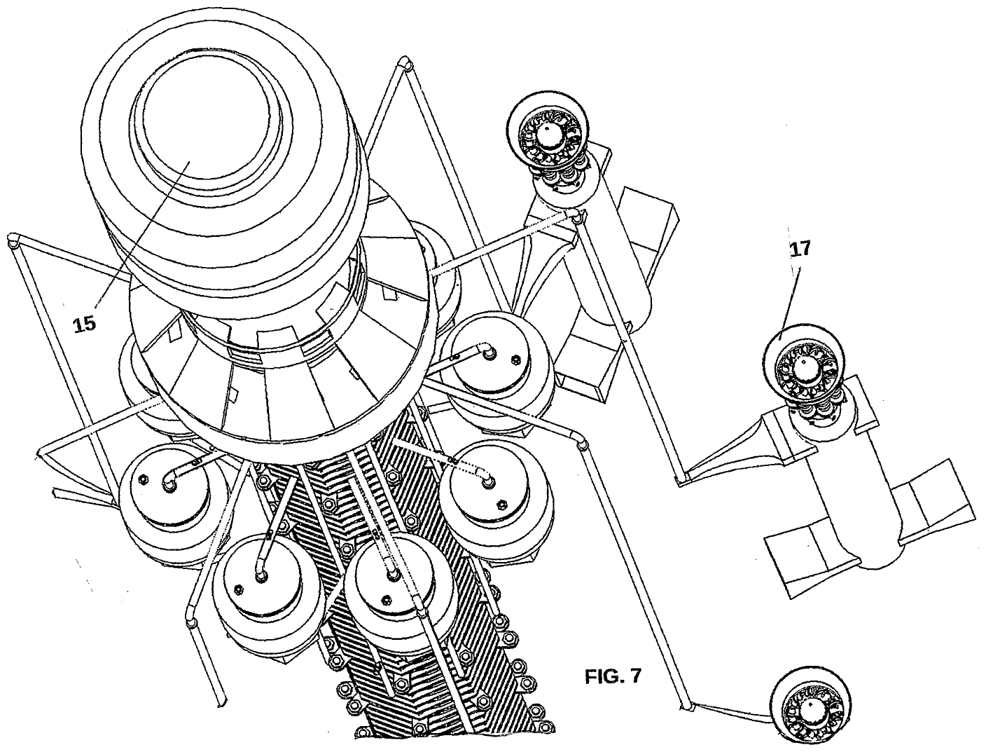

FIG. 8: Archimedes helical screw pump cross-sectional view

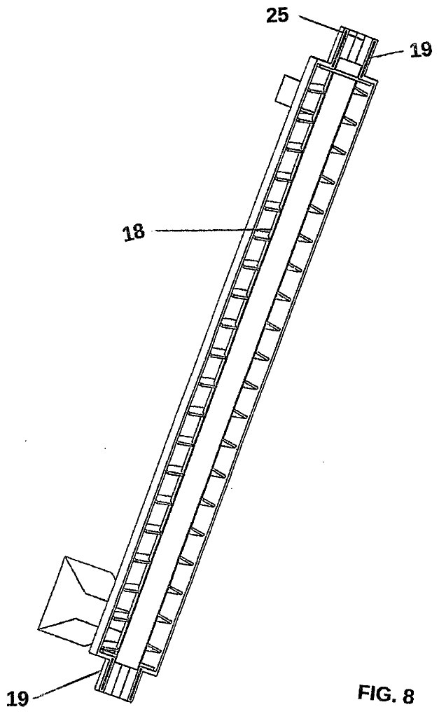

FIG. 9: a cross-sectional view of desalination seawater container and desalination moving actuator

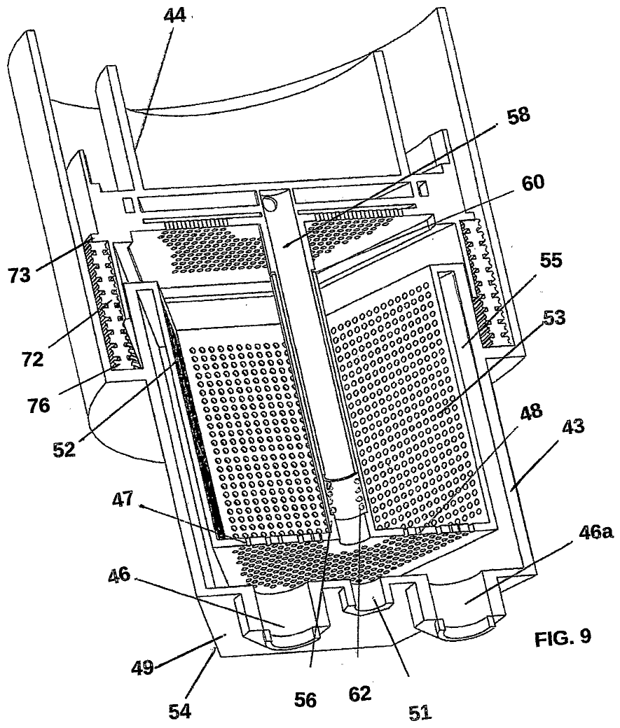

FIG. 10: a cross-sectional view of desalination seawater container and top dome

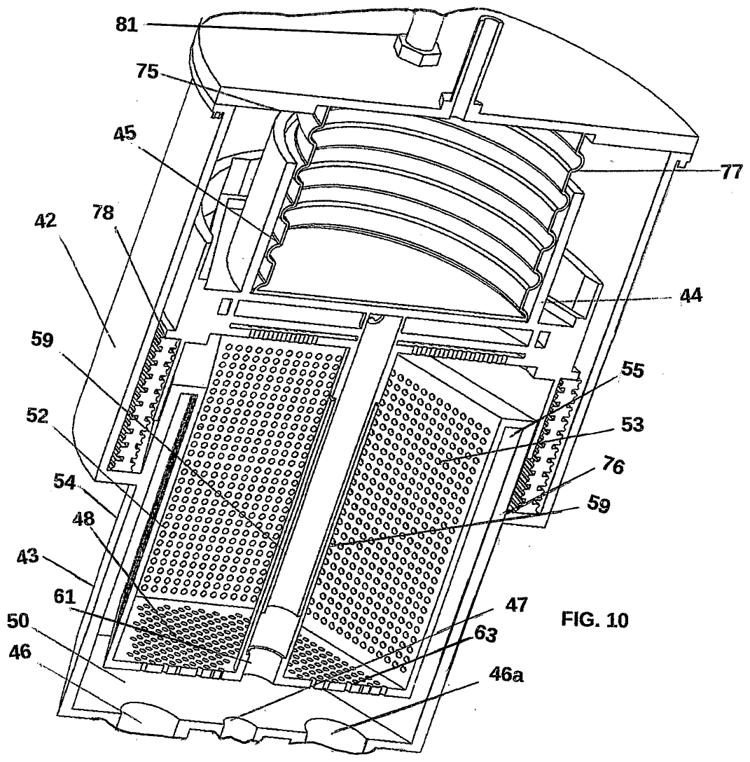

FIG. 11: a cross-sectional view of desalination moving actuator and top dome

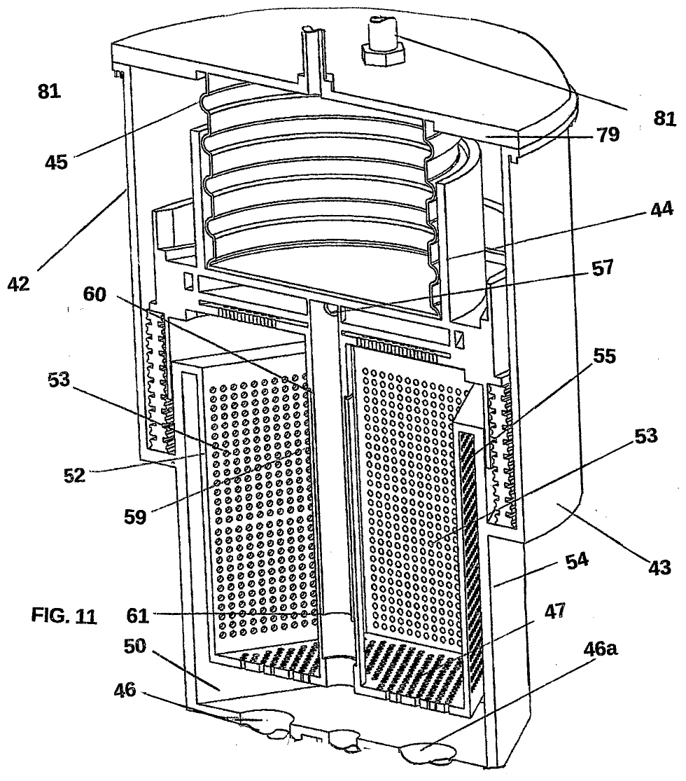

FIG. 12: a cross-sectional view of desalination seawater container and top dome

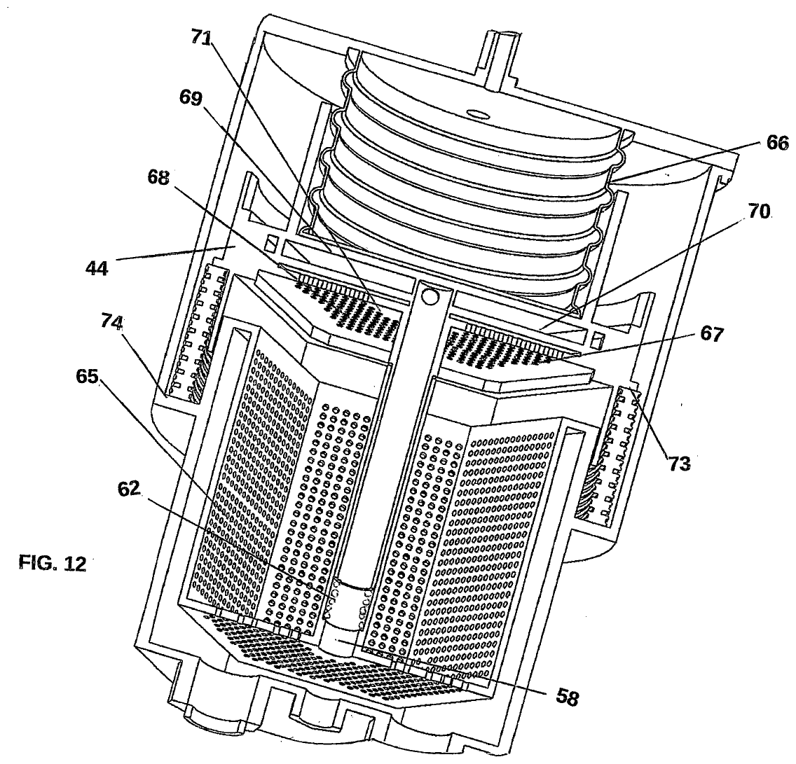

FIG. 13: a top view of the tower secondary water tank and solenoid valve assemblies

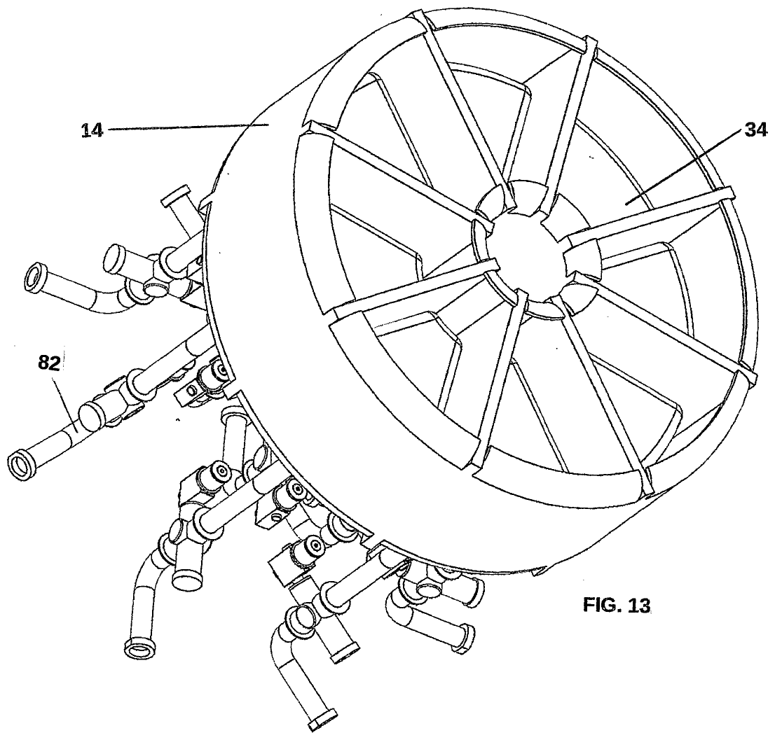

FIG. 14: a top view of the tower supply water tank

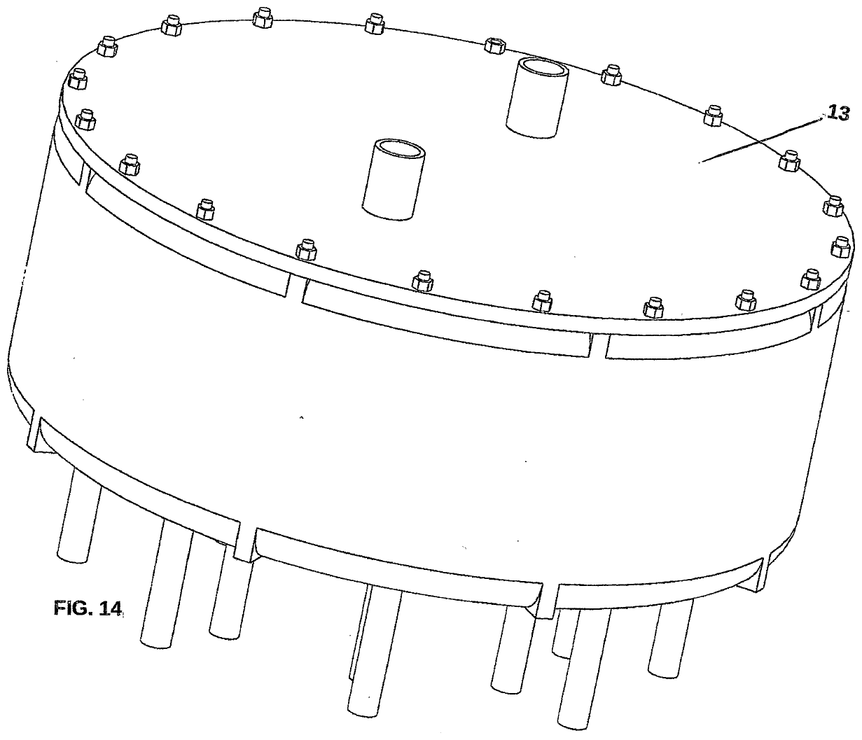

FIG. 15: side view of tower secondary water tank and solenoid valve assemblies

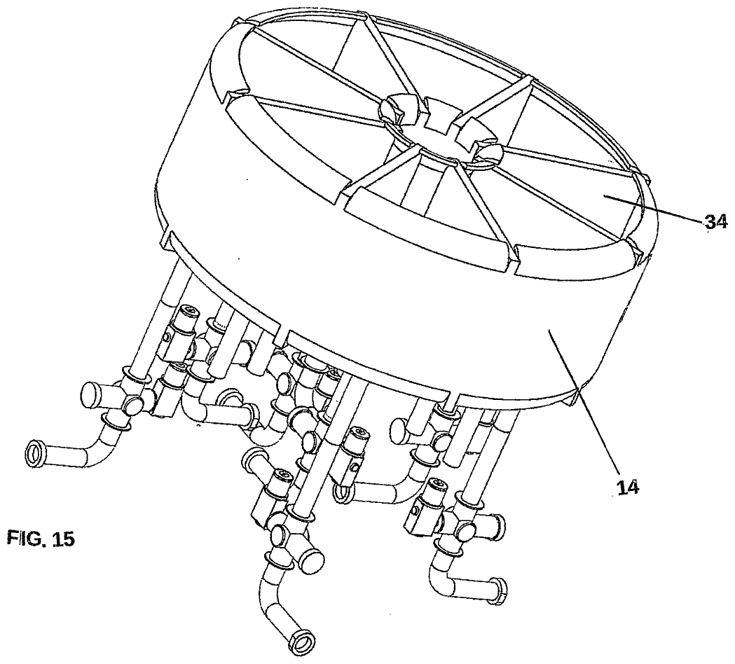

FIG. 16: top view of the tower secondary water tank and air bladder actuators

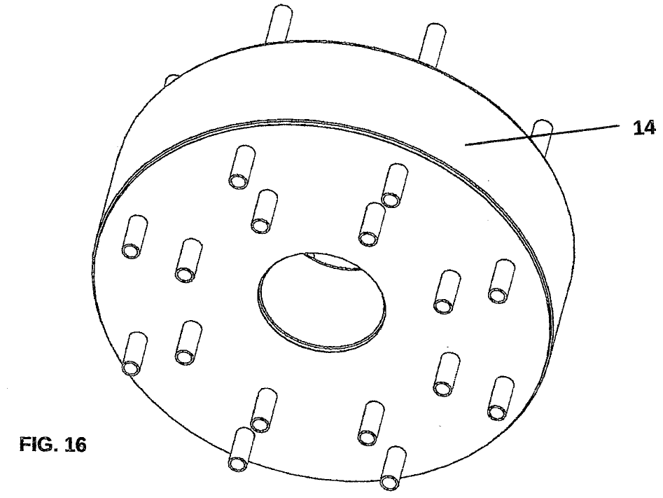

FIG. 17: a cross-sectional view of the tower's secondary water tank

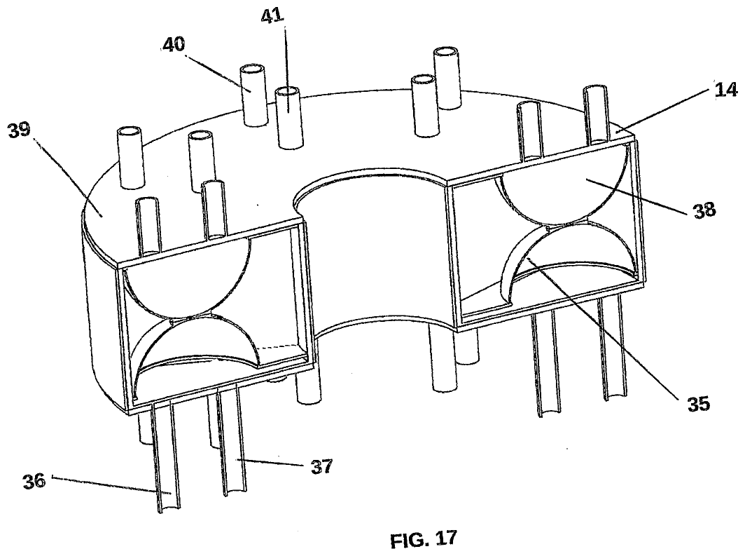

FIG. 18: a top cross-sectional view of the tower's secondary water tank

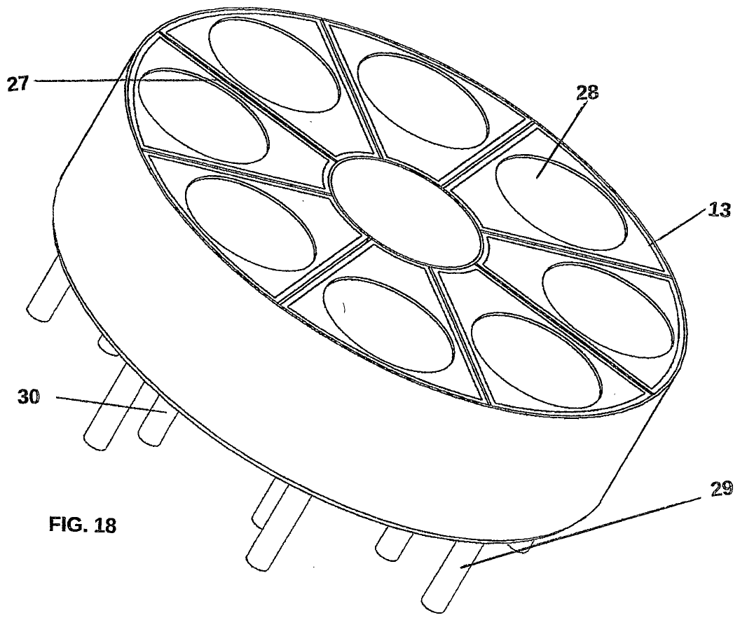

FIG. 19: a top cross-sectional view of the air bladder actuator

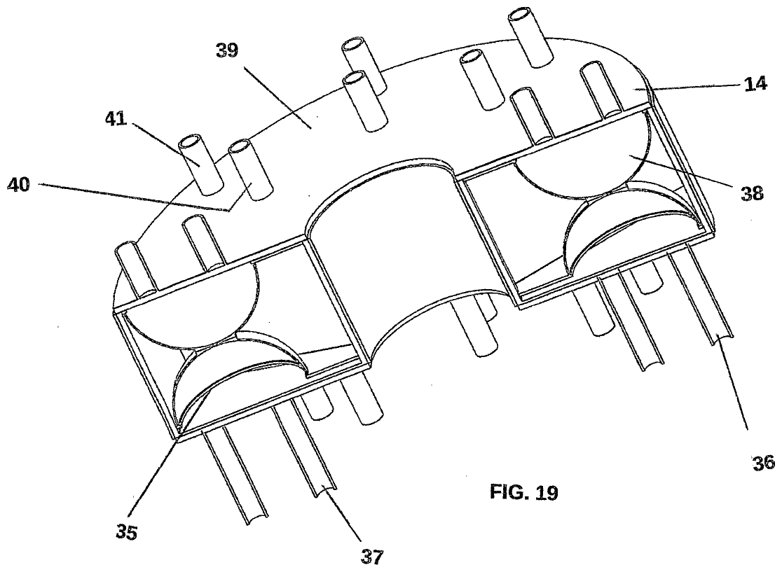

FIG. 20: a bottom cross-sectional view of the water bladder containers

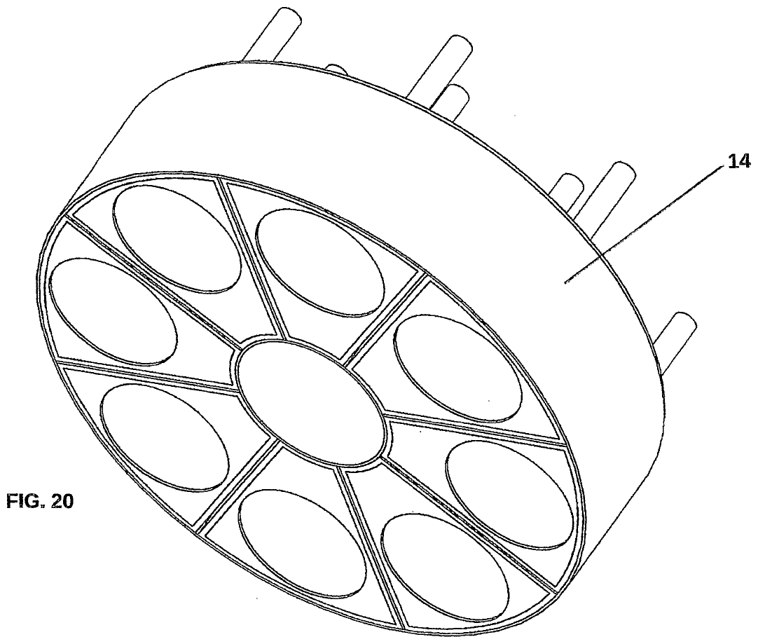

FIG. 21: a top cross-sectional view of the top dome air bellows actuator

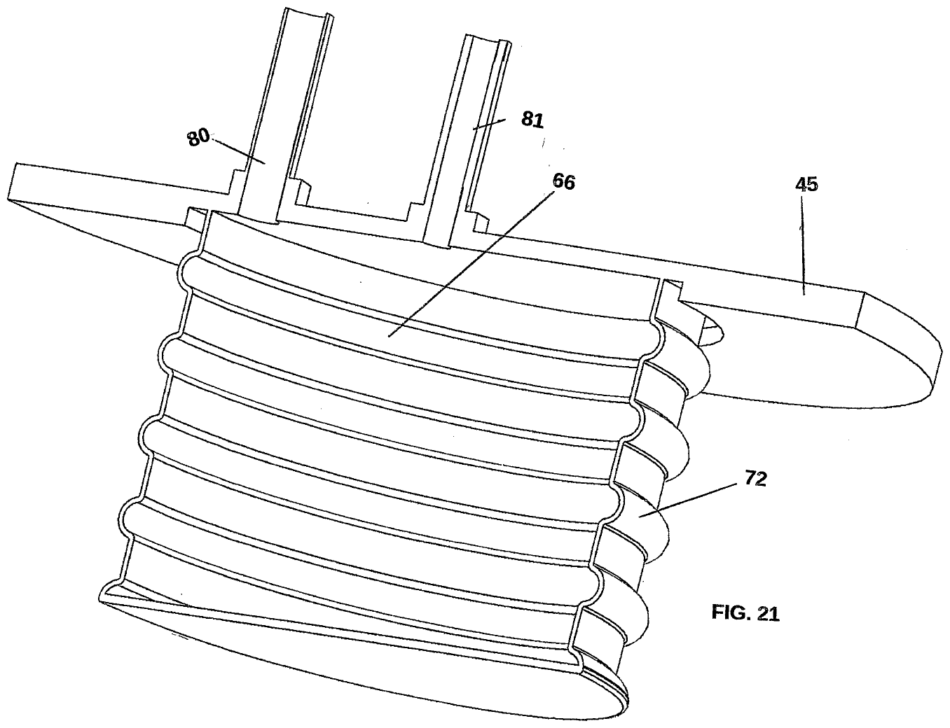

FIG. 22: a top view of the bottom blader container

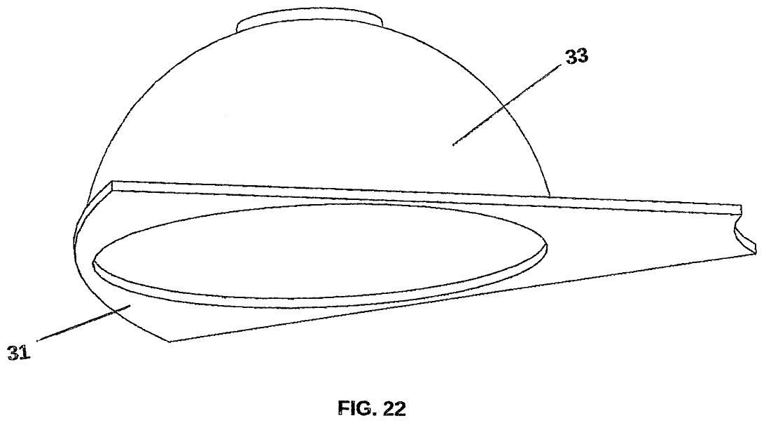

FIG. 23: a top view of the bottom blader container and upper bladder actuator

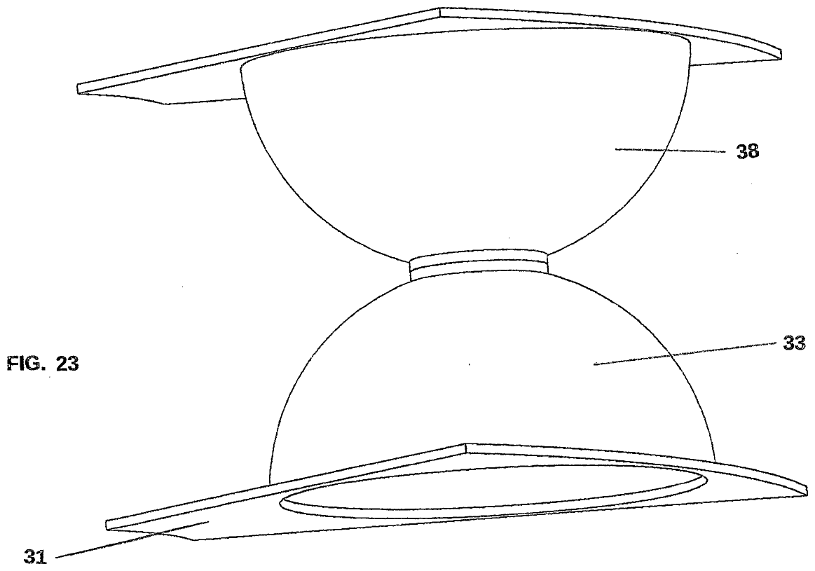

FIG. 24: a bottom view of the bottom blader container

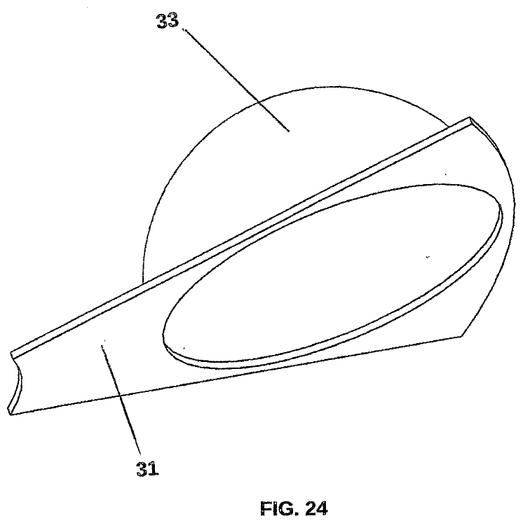

FIG. 25: a side view of the RO membrane support

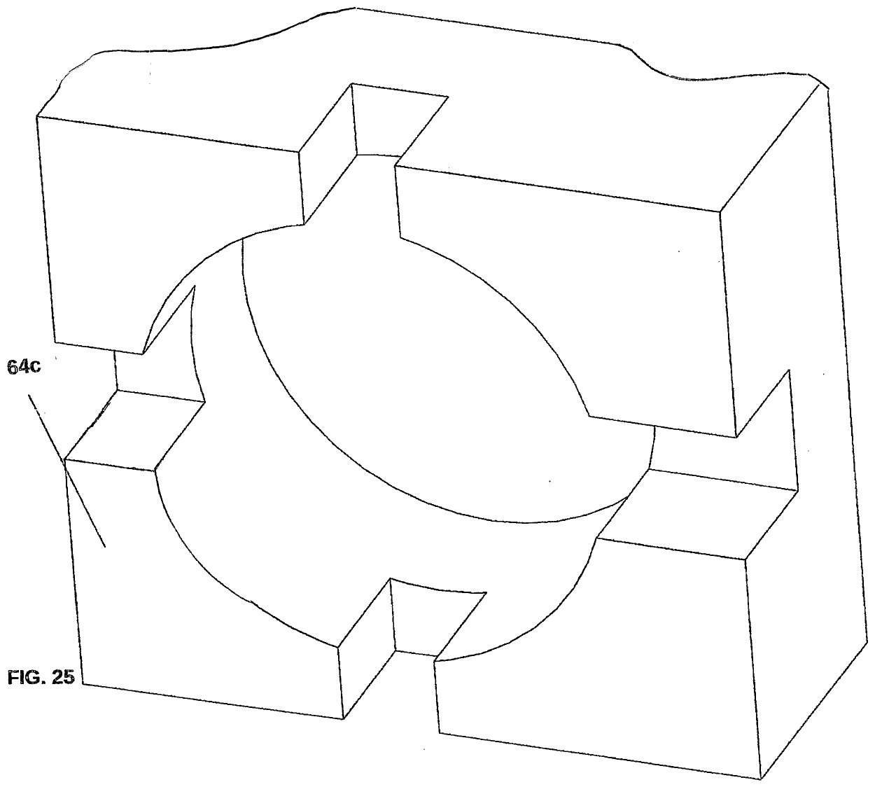

FIG. 26: top view of Reverse Osmosis desalination membrane

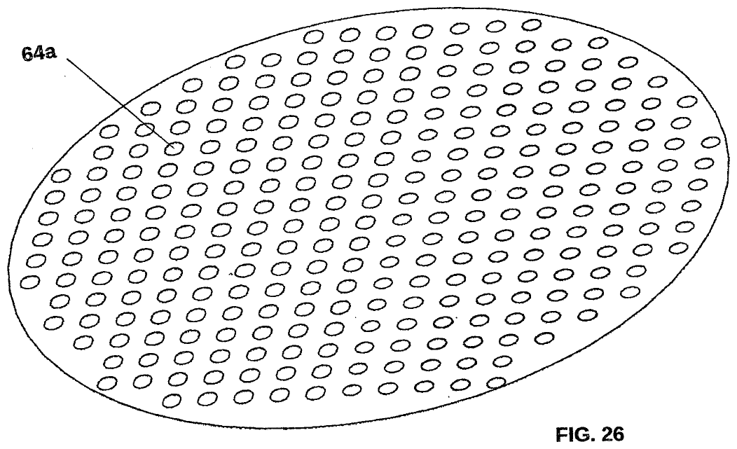

FIG. 27: a side view of the RO filter element filter plate

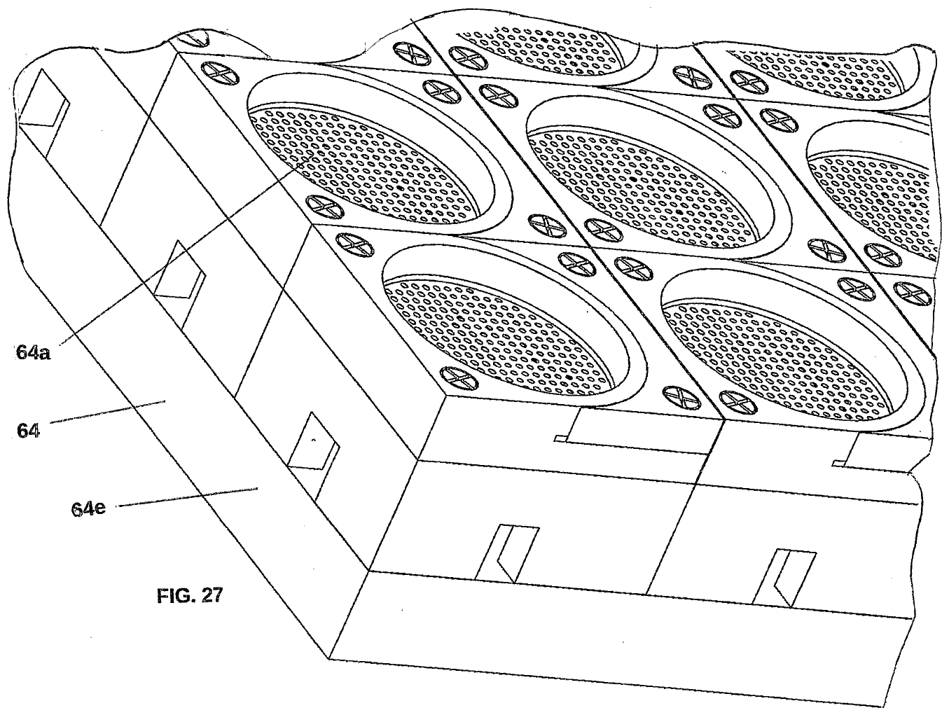

FIG. 28: a top view of RO membrane and holder assembly

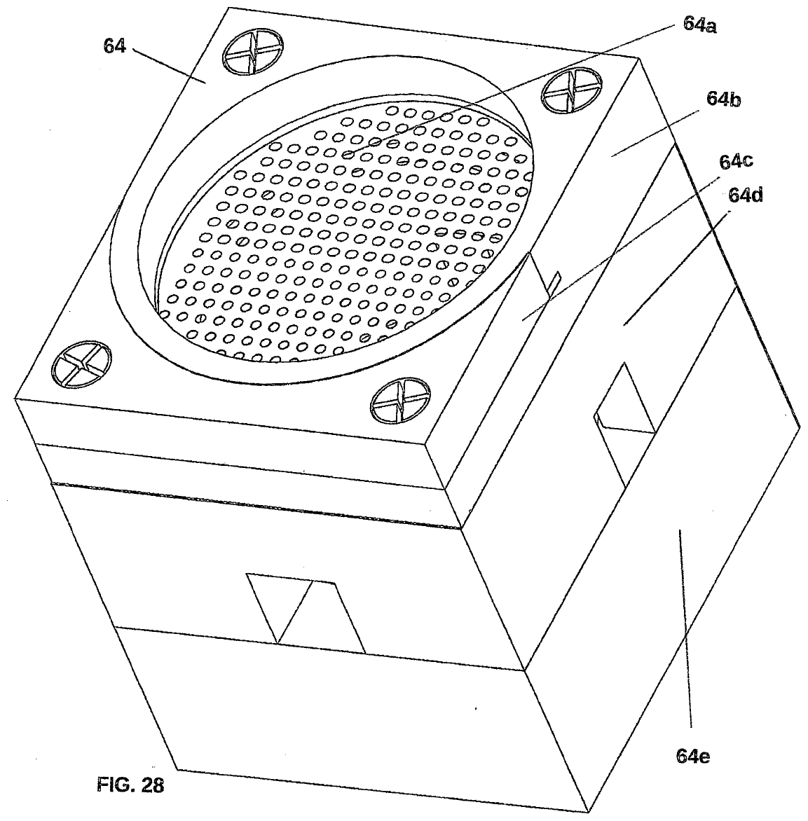

FIG. 29: a detailed view of RO filter assembly

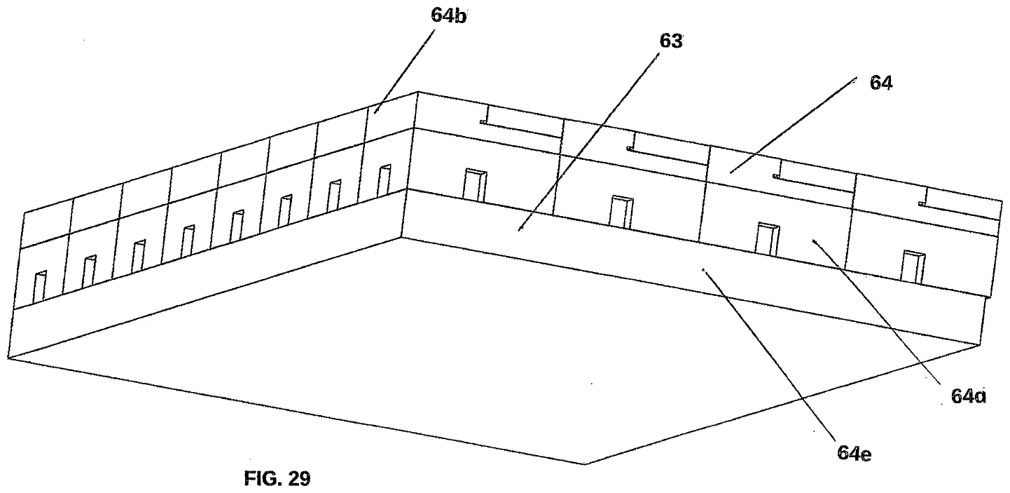

FIG. 30: assembly of multiple RO desalination elements

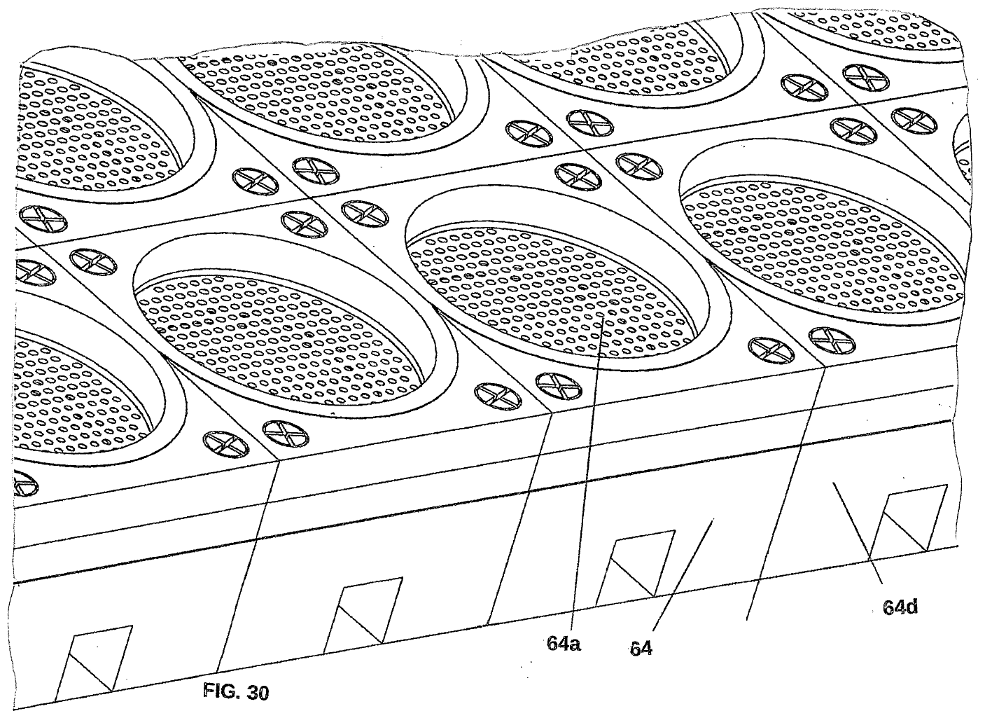

FIG. 31: RO membrane holder

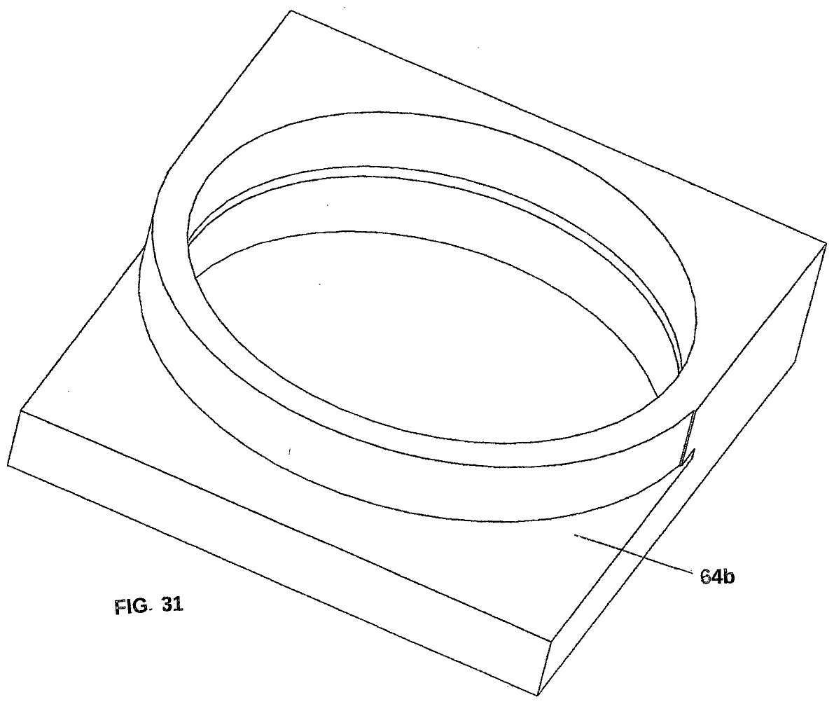

FIG. 32: RO membrane and holder multiple assemblies

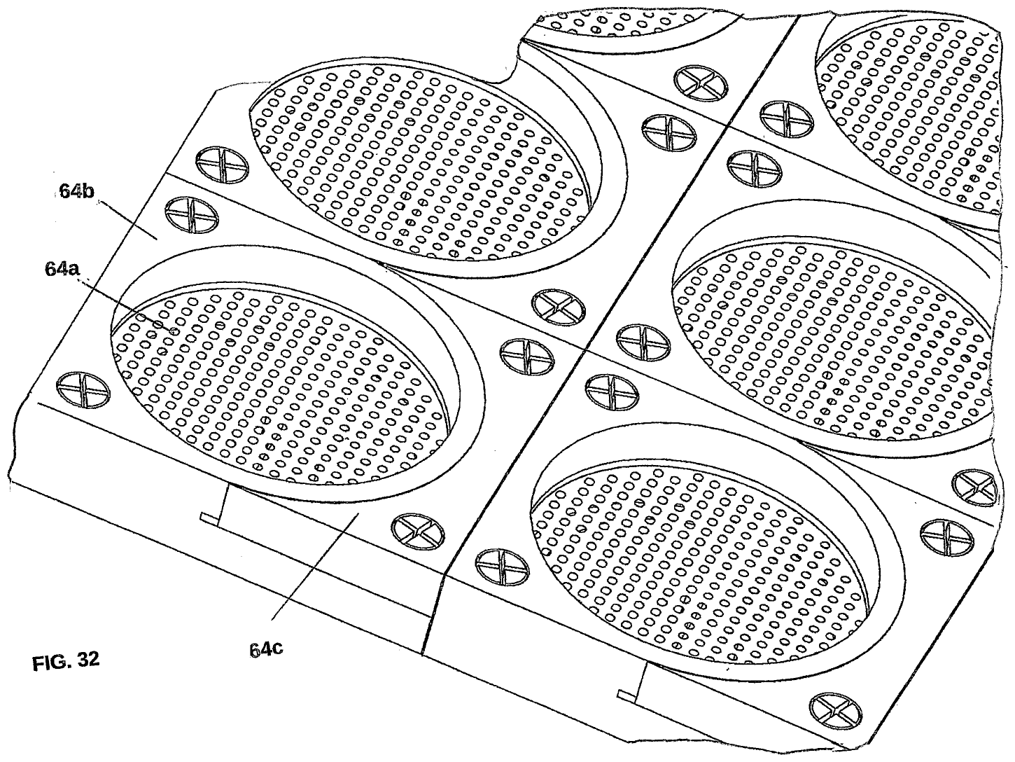

FIG. 33: top dome solenoid valve assembly

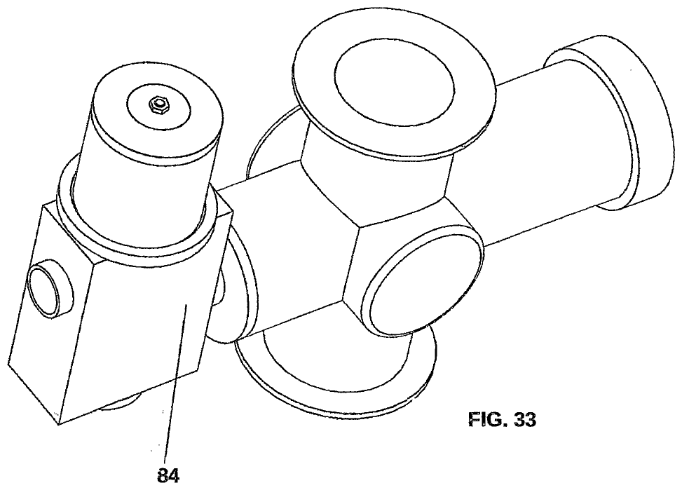

FIG. 34: solenoid valve assembly and water pipe assembly

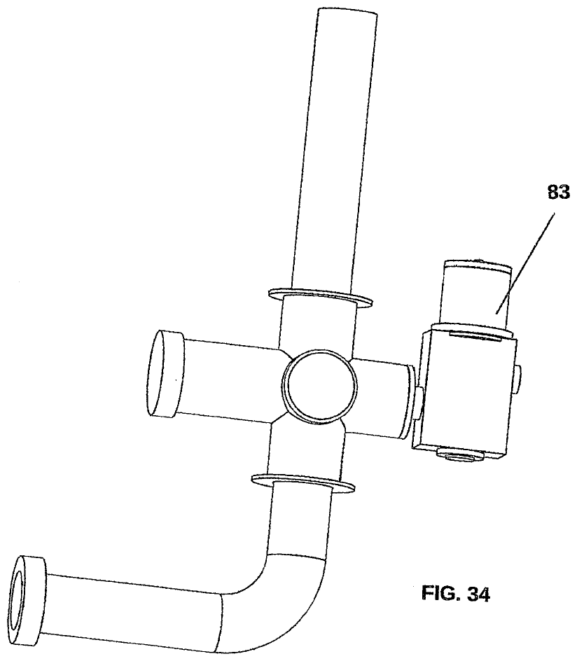

FIG. 35: desalination tower and 16 desalination apparatus

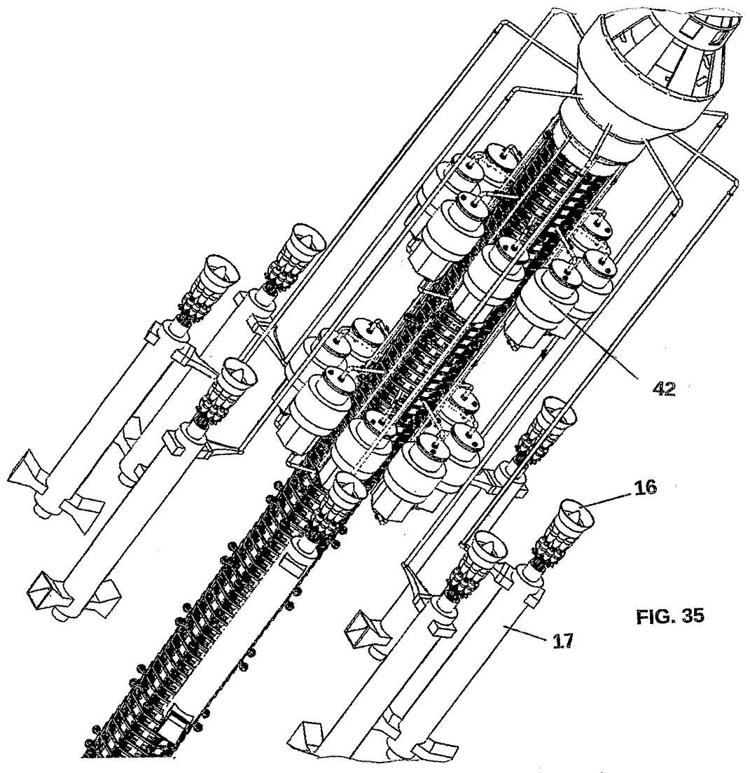

FIG. 36: bottom view of desalination tower and 16 desalination apparatus

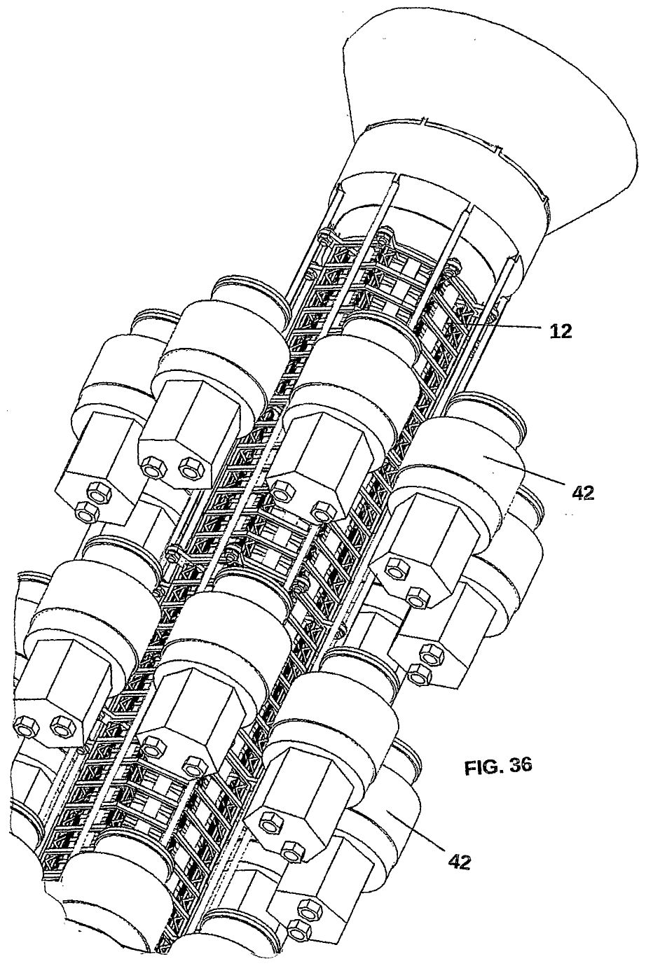

FIG. 37: tower sectional construction and desalination apparatus

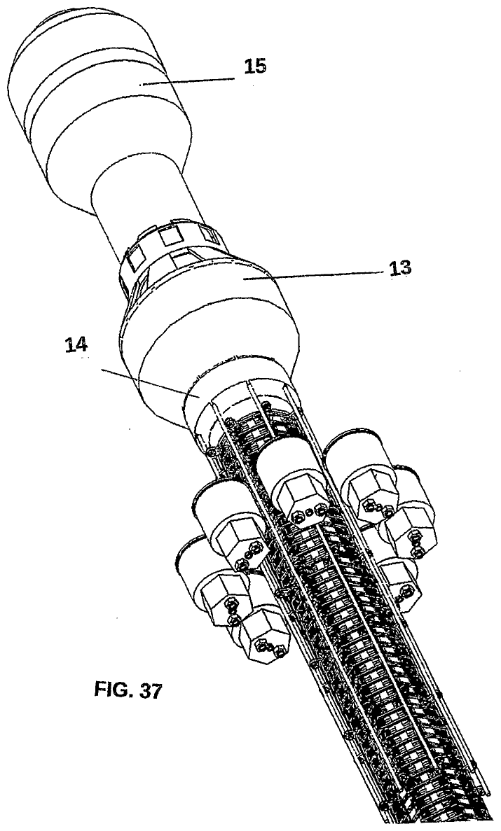

FIG. 38: desalination tower and 24 desalination apparatus

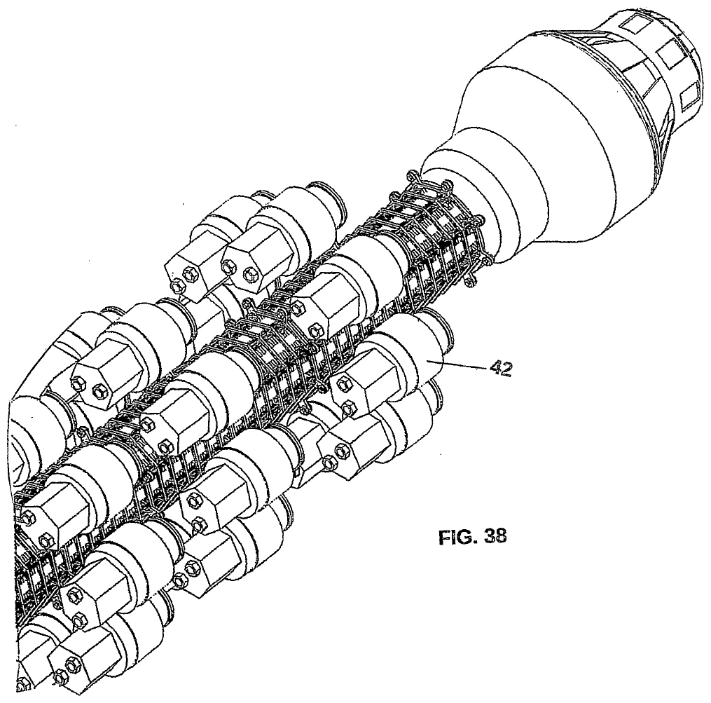

### DETAIL DESCRIPTION OF THE INVENTION

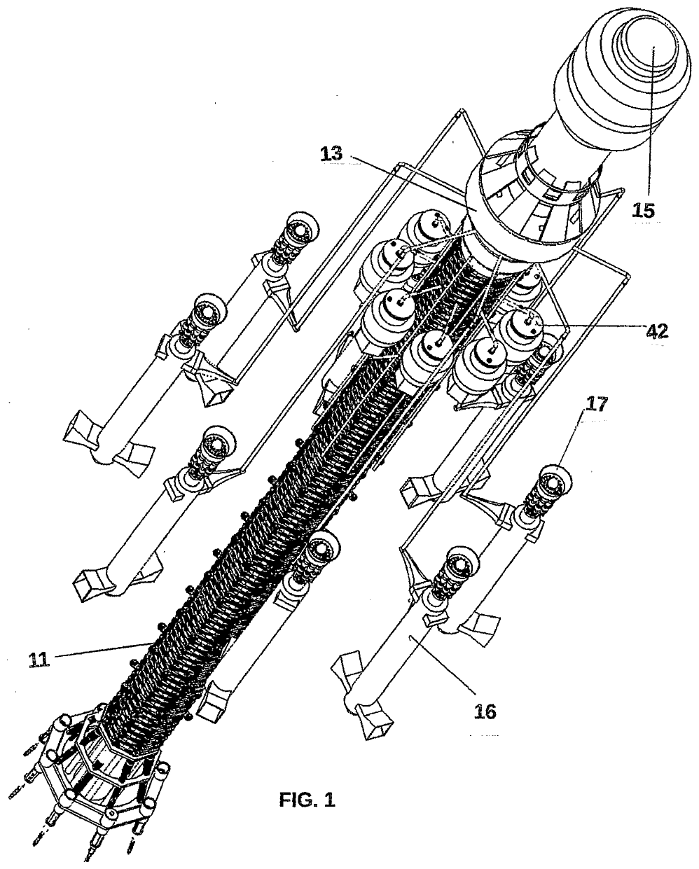

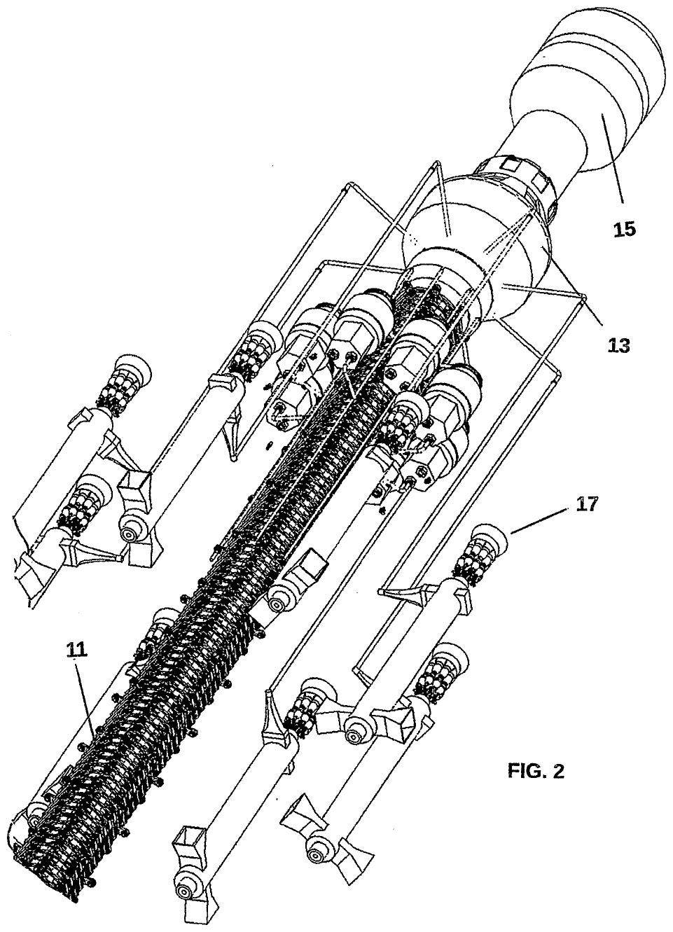

Offshore Ocean seawater desalination system into drinking water using ocean and wave nature power of pneumatic compressed air, comprising:
A. FIG. 1 presents a construction of a desalination tower 11 comprises of multiple tower bolted construction sections 12 extending from more than 50 feet above sea level and submerged in ocean water and mooring to seabed up to 100 meters deep constructively supporting a tower supply water tank 13, a tower secondary water tank 14, and a tower pressurized air tank 15.
B. FIG. 2 presents an Archimedes screw water pump 16 powered by a Pulsed Supersonic Air Turbine Engine 17 with Electronic Speed Control. The Air-Turbine Engine has an engine air tank inlet port connected to tower pressurized air tank 15, and Electronic Speed Control controls the engine speed.
C. The Archimedes screw water pump 16 consists of a pump rotating helical screw 18, which is supported axially by two pump helical screw ball bearings 19 that are sealed with lifetime lubrication. The pump rotating helical screw 18 turns inside a cylindrical water pump housing 20, having a tightly controlled radial clearance between them to prevent high leakage between the screw and housing for the buildup of water pressure at the pump outlet. The Archimedes screw water pump 16, having a submerged pump inlet port 21, is located 20 feet below seawater level, including a submerged pump inlet port filter 22 to prevent contamination of the RO filter elements with sea Plankton. The pump tapered outlet port 23 is tapered to reduce its water-flow cross-sectional area before flow continues in a water supply connection pipe 24. It builds water pressure of up to 250 psig at the inlet port of tower supply water tank 13. The pump top shaft-end 25 of the pump rotating helical screw 18 is torque-coupled with the outlet shaft of the Pulsed Supersonic Air-Turbine Engine 17, thereby the pump rotating helical screw is powered by the air-turbine engine with electronically controlled speed which controls water pressure in the tower supply water tank 13 using output voltage of pressure sensor 26 that is mounted to the inlet of the supply water tank. The pressure sensor 26 senses the pressure of the water within the tower supply water tank 13 and provides a voltage input to the engine electronic speed control of the air-turbine engine 17, causing the engine rotation speed to be reduced to prevent water overpressure above pre-set maximum pressure in the tower supply water tank 13.
D. A tower supply water tank 13 is structurally bolted to said a desalination tower 11 at 50 feet above seawater level and is divided radially into eight tower supply water tank chambers 27, each containing a flexible rubber-made with fabric reinforcement water-containing supply water tank bladder 28 having a supply water tank bladder inlet port 29 and a supply water tank bladder outlet port 30. The eight supply water tank bladders 28 filled with seawater occupy the volume of eight tower supply water tank chambers 27 having a flat bladder bottom surface 31 bolted to the supply water tank chamber floor 32 and having a bladder upper half-spherical top 33. Seawater at a pressure of 150 psig from the Archimedes screw water pump 16 enters the bladder inlet port 29 until it fills the entire volume of the tower supply water tank chamber 27. The supply water tank bladder outlet port 30 is connected to a secondary tower water tank 14 which is mounted axially underneath said tower supply water tank 13. Therefore, the eight tower supply water tank bladders store pressurized water continuously and supply water under pressure to the tower's secondary water tank 14.

A tower secondary water tank 14 located axially under the tower supply water tank 13 structurally bolted to the desalination tower 11 at 40 feet above seawater level and is divided radially into eight secondary water tank chambers 34, each containing a flexible rubber-made fabric reinforced water containing volume with fabric reinforcement secondary water tank bladder 35 having a secondary water tank bladder bottom inlet port 36 and a secondary water pump bladder bottom outlet port 37. The eight secondary water tank bladders 35 filled with pressurized seawater through their inlet ports 36 are connected to the supply water tank bladder outlet port 29. In addition, the secondary tower water tank's eight chambers 34 consist of top eight secondary water tank air bladder actuators 38 with semi-spherical top and with a flat top base bolted to the secondary water tank top cover 39 having an air bladder air actuator inlet port 40 and having an air bladder air actuator outlet port 41. The semi-circular lower portion of the bladder air actuator 41 engages with the top semi-circular portion of the water bladder and squeezes water from it under air pressure.

Eight desalination apparatus units 42 are structurally bolted to the desalination tower 11. Each desalination apparatus unit 42 independently converts seawater into drinking water and comprises a desalination seawater container 43, a desalination moving actuator 44, and a desalination top dome 45. The seawater flows into the desalination seawater container inlet port 46 of each of the eight desalination apparatus units 42 from each of the eight tower secondary water tank water chambers 34 through the secondary water tank outlet port 37 at 150 psig water pressure. The desalination seawater container outlet port 46a is closed by a solenoid valve assembly 85 to allow seawater filling of the desalination seawater container 43.
E. the desalination seawater container comprises:
   An inner bottom plate 47 with a hole pattern 48 parallel to the external bottom plate 49, thereby creating a bottom flow cavity 50 for collecting the drinking water after passing through the Reverse Osmosis filter.
   The drinking water is collected in drinking water bottom flow cavity 50 between the bottom plates 47 and 49, with drinking water flowing down through drinking water outlet port 51 into an external ocean floatable drinking water container.
   The desalination seawater container 43 further has six container hexagon inner vertical walls 52, each with a vertical wall through hole pattern 53, each parallel to the external container hexagon vertical wall 54, thereby creating a vertical drinking water flow cavity 55 between the parallel inner and external vertical hexagon walls for collecting the drinking water after passing through the Reverse
   Osmosis filters and flowing downwards through drinking water bottom flow cavity 50 towards the drinking water outlet port 51.
   A vertical cylindrical hollow guide pole 56 bolted to the container bottom inner plate 47 with a pole lateral through hole 57 close to its top and a connecting flow center hole 58 into the drinking water bottom cavity 50. An external concentric hollow pole 59 which is an extension part of the desalination moving actuator, slides smoothly at controlled, tight clearance over the cylindrical hollow guide pole 56.
   The axial up and down movement of the desalination moving actuator 44 is limited by an actuator upper mechanical stop 60 and an actuator lower mechanical stop 61 that is controlled by the length of the vertical hollow guide pole 56 and the external concentric pole 59.
   A helical compression spring 62 guided radially by the outer diameter of the vertical cylindrical hollow guide pole 56 and guided axially by the container bottom inner plate 47 applies an upward force on the desalination moving actuator's external concentric pole 59, pushing it up to the upper mechanical stop 57.
   The Desalination RO filter element 64 comprises
      a. Reverse Osmosis circular membrane 64a of 2″ diameter
      b. RO Membrane holder 64b
      c. RO Membrane end holder 64c
      d. RO Membrane holder bottom support 64d
      e. RO Filter plate support 64e
   The desalination bottom RO filter plate assembly 63 with multiple embedded RO filter elements 64 is bolted to the container bottom inner plate 47, thereby the seawater in the container forced down by the desalination moving actuator applies a high water pressure of 800-1000 psig on the embedded RO filter elements 64 of the bottom desalination RO filter plate assembly 63 for the reverse osmosis process, pushing drinking water molecules through the desalination bottom filter assembly plate 63 and then through the inner bottom through hole pattern 48 holes and then into the bottom drinking water flow cavity 50 flowing toward the drinking water outlet port 51.
   The desalination vertical hexagon RO filter plate assembly 65 with multiple embedded RO filter elements 64 is bolted to the container vertical hexagon inner plate 52, thereby the seawater in the container forced down by the desalination moving actuator applies a high water pressure of 800-1000 psig on the embedded RO filter elements 64 of the desalination vertical hexagon RO filter plate assembly 65 for the reverse osmosis process, pushing drinking water molecules through the desalination vertical hexagon filter assembly plate 65 and then through the inner vertical hexagon through hole pattern 53 holes and then into the bottom drinking water flow cavity 50 flowing toward the drinking water outlet port 51.
F. The desalination moving actuator 44 comprises
The desalination moving actuator 44 cycles up under seawater pressure force in the seawater container and the upward pressure force of the helical compression spring 62 force.
   1. The desalination moving actuator 44 cycles down under the downward force of the high air pressure top dome bellows actuator 66 when high-pressure air in the dome bellows actuator has axial flexible bellow, which allows axial travel of the actuator.
   2. A desalination moving actuator 44 with a moving actuator bottom plate 67 with through hole pattern 68 and an upper parallel plate 69 creates a moving container upper drinking water flow cavity 70 for collecting the drinking water after passing through the Reverse Osmosis filter.
   3. The moving actuator desalination RO filter assembly plate 71 with multiple embedded reverse osmosis filter elements 64 is bolted to said moving actuator bottom inner plate 67, thereby high seawater pressure in the seawater container applying high water pressure of 800-1000 psig on the top moving desalination filter assembly plate 71 for the reverse osmosis process, pushing drinking water flows through the desalination upper filter assembly plate 64 and then through the pattern through holes 68 and then into the upper drinking water flow cavity 70 and then through the pole lateral through hole 57 and then flow through the pole flow connecting center hole 58 into the bottom drinking water flow cavity 50 flowing toward the drinking water outlet port 51.
   4. A radial flexible rubber with fabric reinforcement moving actuator bellow type seal 72 with axial extension capability bolted to the desalination moving actuator seal flange 73 and to the desalination water container seal flange 74, thereby the bellows extends axially during travel of the desalination moving actuator 44, keeping the sealing of the seawater container seawater under pressure in the desalination seawater container and prevents external seawater leakage upwards out of the desalination seawater container.
G. The top dome 45 with top dome radial flange 75 bolted to the desalination seawater container radial flange 76, comprises:
   1. A flexible rubber with fabric reinforcement top dome bellow actuator 77 with axial extension capability bolted and sealed to the desalination moving actuator top flange 78 and the top dome upper flange 79 and pushing said desalination moving actuator 44 down when the high-pressure air of 1200 psig pressurizes inside the top dome bellows actuator 77, therefore overcoming the force applied to the desalination moving actuator by seawater pressure in said desalination seawater container 43 and by the helical compression spring 62.
   2. Top dome bellow air inlet port 80 connects high-pressure air from the desalination air tank 13 at 1200 psig into the top dome air bellow actuator 77, thereby filling the actuator with compressed air and pushing the desalination moving actuator downward against water pressure in desalination seawater tank 43 and against compression spring 62 upward force.
   3. Top dome bellow air outlet port 81 connects the top dome air bellow actuator 77 to the top tower secondary water tank air inlet port 40, thereby pressurizing the secondary water tank top air bladder with up to 200 psig against the secondary water tank water bladder 35 and squeezing water under pressure into the inlet of desalination seawater container inlet port 46.
H. The top dome Inlet port air solenoid valve assembly 82 with one-way flow comprising a high-pressure air solenoid operated by DC electronic controller voltage, with the solenoid assembly 82 inlet port connected to the tower pressurized air tank 15, and with the solenoid valve assembly 82 outlet port connected high-pressure air to the top dome bellows actuator inlet port 80, thereby increasing the air pressure in the top dome bellows bladder, pushing said desalination moving actuator 44 downwards to the lower mechanical stop.
J. The top dome outlet port air solenoid valve assembly 83 with one-way flow comprising a high-pressure air solenoid operated by DC electronic controller voltage, with the solenoid assembly 83 inlet port connected to the air outlet port of the top dome connects high-pressure air from the top dome bellows actuator outlet port 81 into the secondary water tank bladder air actuator outlet port 40, thereby applying pressure force on the water-filled bladder and increasing water pressure in the bladder to squeeze water flow into said desalination seawater container 43.
K. The desalination seawater container Inlet port seawater solenoid valve assembly 84 with a one-way flow comprising a solenoid operated by DC electronic controller voltage with solenoid assembly 84 inlet port connected to the secondary water tank water bladder outlet port 37, and the solenoid outlet port is connected to the desalination seawater container inlet port 46, thereby filling the desalination seawater container with pressurized seawater.
L. The desalination seawater container outlet port solenoid seawater valve assembly 85 with a one-way flow comprising a solenoid operated by DC electronic controller voltage with solenoid valve assembly 85 inlet port connected to desalination seawater container outlet port 46a and the solenoid valve assembly outlet port is connected to the ocean seawater return pipe, thereby removing the unused 70% of the seawater and dumping them back to the ocean.
M. The drinking water outlet port solenoid valve assembly 86 with one-way flow comprising a solenoid operated by DC electronic controller voltage with a solenoid valve assembly 86 inlet port connected to the desalination seawater container drinking water outlet port 51 and with the solenoid valve assembly 86 outlet port connected to the drinking water tank that is floatable in the ocean seawater.
N. The desalination seawater container pressure sensor 87 with the pressure sensing probe is located within the desalination seawater container. It provides a linear voltage output proportional to said water pressure to the DC electronic controller. Thereby when pressure is below 1000 psig, said top dome air inlet solenoid valve assembly 82 is DC voltage-activated, while when the pressure increase above 1000 psig, said top dome air inlet solenoid valve assembly 82 is deactivated.
O. A lower mechanical stop magnetic position switch 88 is located outside the desalination seawater container 43 external hexagonal wall 54. In addition, a magnet is attached to said desalination moving actuator 44 at lower and upper mechanical stop locations.
P. a pressure relief valve 89 set at 300 psig at the outlet of the secondary water tank air bladder actuator outlet port

### Description of the Desalination Cycling Process:

1. Starting Cycle Condition

The desalination process starts when the desalination moving actuator is at the upper mechanical stop position 60. There is a low pressure of less than 30 psig in the top dome bellows actuator 77. There is low-pressure seawater of less than 30 psig in the desalination seawater container 43. The desalination water container outlet port solenoid valve assembly 85 is in normally open, with the DC power ‘off’ position. The desalination water container inlet port solenoid valve assembly 84 is in the normally closed, with DC power ‘on’ position; therefore, water enters the desalination seawater container 43 and flows through the desalination seawater container outlet port 46a out and back to the ocean, therefore cleaning the container RO filter plates from residuals.

2. The Next Desalination Process Phase

The next desalination phase starts when the desalination electronic controller commands the desalination water container outlet port solenoid valve assembly to close, with the DC power ‘on’ position. The desalination seawater container is starting to fill its volume, and the container seawater pressure rises to 200 psig. When the desalination seawater container pressure sensor 87 input to the desalination electronic controller is 200 psig, the desalination electronic controller turns DC power ‘on’ to the top dome inlet port solenoid valve assembly 82, the air pressure in the top dome bellows actuator increases and the desalination moving actuator 44 moves down towards the lower mechanical stop 61. The seawater pressure in the desalination seawater container increases by the force that is applied by the desalination moving actuator 44 move down. When the seawater pressure input by the pressure sensor reaches 1000 psig, the desalination electronic controller turns DC power ‘off’ to the top dome inlet port solenoid valve assembly 82, keeping the pressure constant at 1000 psig by ‘off’ and ‘on’ commands. The desalination moving actuator 44 moves down slowly towards the lower mechanical stop 61, with the desalinated drinking water flowing through the RO membranes in the bottom, top, and vertical hexagon RO filter plates. When the desalination moving actuator 44 reaches the lower mechanical stop 61, the magnetic position sensor 88 input to the desalination electronic controller means the end of the desalination process.

3. The After-Desalination Process Phase

The desalination electronic controller turns DC power ‘off’ to the top dome inlet port solenoid valve assembly 82. The desalination electronic controller turns DC power ‘on’ to the normally-closed top dome outlet port solenoid valve assembly 83. The air pressure in the top dome bellows the actuator is reduced when it flows into the secondary water tank air bladder actuator inlet port 40 and applies up to 300 psig forcing the water out of the secondary water tank water bladder. The desalination electronic controller turns DC power ‘off’ to the normally-open desalination seawater container outlet port solenoid assembly 83 and allows water out of the desalination seawater container. The system is ready to start a new desalination cycle.

1. An offshore ocean seawater desalination into drinking water apparatus using ocean wave and stream nature power converted to pneumatic compressed air, comprising:
A. a desalination tower comprised of multiple tower's bolted construction sections extending from more than 50 feet above sea level and submerged in ocean water and mooring to seabed up to 100 meters deep constructively supporting a tower supply water tank, a tower secondary water tank, and a tower pressurized air tank.
B. an Archimedes screw water pump powered by a pulsed supersonic air turbine engine with electronic speed control, the air-turbine engine has an engine air tank inlet port connected to the tower's pressurized air tank, and the engine speed is controlled by electronic speed control.
C. the Archimedes screw water pump consists of a pump rotating helical screw which is supported axially by two pump helical screw ball bearings that are sealed with lifetime lubrication; comprises:
1. the pump rotating helical screw turns inside a cylindrical water pump housing has a tightly controlled radial clearance between them to prevent high leakage between the screw and housing for the buildup of water pressure at the pump outlet, and
2. the Archimedes screw water pump having a submerged pump inlet port is located 20 feet below seawater level including a submerged pump inlet port filter to prevent contamination of the RO filter elements with sea Plankton, and
3. the pump tapered outlet port is tapered to reduce its water-flow cross-sectional area before flow continues in a water supply connection pipe building water pressure of up to 250 psig at the inlet port of the tower supply water tank, and
4. the pump top shaft-end of the pump rotating helical screw is torque-coupled with the outlet shaft of the pulsed supersonic air-turbine engine, thereby the pump rotating helical screw is powered by the air-turbine engine with electronically controlled speed which controls water pressure in the tower supply water tank, using output voltage of pressure sensor that is mounted to the inlet of the supply water tank, and
5. the pressure sensor senses the pressure of the water within the tower supply water tank and provides a voltage input to the engine electronic speed control of the air-turbine engine, causing the engine rotation speed reduced to prevent water overpressure above pre-set maximum pressure in the tower supply water tank, and
D. a tower supply water tank is structurally bolted to said a desalination tower at 50 feet above seawater level and is divided radially into eight tower supply water tank chambers, each containing a flexible rubber-made with fabric reinforcement water-containing supply water tank bladder having a supply water tank bladder inlet port and a supply water tank bladder outlet port, and
the eight supply water tank bladders filled with seawater occupy the volume of eight tower supply water tank chambers having a flat bladder bottom surface bolted to the supply water tank chamber floor and having a bladder upper half-spherical top, and
seawater at a pressure of 150 psig from the Archimedes screw water pump enters the bladder inlet port until it fills the entire volume of the tower supply water tank chamber, and
the supply water tank bladder outlet port is connected to a secondary tower water tank which is mounted axially underneath said tower supply water tank, therefore, the eight tower supply water tank bladders store pressurized water continuously and supply water under pressure to the tower's secondary water tank, and
a tower secondary water tank located axially under the tower supply water tank structurally bolted to the desalination tower at 40 feet above seawater level and is divided radially into eight secondary water tank chambers, each containing a flexible rubber-made fabric reinforced water containing volume with fabric reinforcement secondary water tank bladder having a secondary water tank bladder bottom inlet port and a secondary water pump bladder bottom outlet port, and
the eight secondary water tank bladders filled with pressurized seawater through their inlet ports are connected to the supply water tank bladder outlet port, and
the secondary tower water tank's eight chambers consist of top eight secondary water tank air bladder actuators with semi-spherical top and with a flat top base bolted to the secondary water tank top cover having an air bladder air actuator inlet port and having an air bladder air actuator outlet port, and
the semi-circular lower portion of the bladder air actuator engages with the top semi-circular portion of the water bladder and squeezes water from it under air pressure, and
eight desalination apparatus units are structurally bolted to the desalination tower, each desalination apparatus unit independently converts seawater into drinking water and is comprised of a desalination seawater container, a desalination moving actuator, and a desalination top dome and an electronic controller, and
the seawater flows into the desalination seawater container inlet port of each of the eight desalination apparatus units from each of the eight tower secondary water tank water chambers through the secondary water tank outlet port at 150 psig water pressure, and
the desalination seawater container outlet port is closed by a solenoid valve assembly to allow seawater filling of the desalination seawater container, and
E. the desalination seawater container comprises
1. an inner bottom plate with a hole pattern parallel to the external bottom plate, thereby creating a bottom flow cavity for collecting the drinking water after passing through the Reverse Osmosis filter, and
2. The drinking water is collected in the drinking water bottom flow cavity between the bottom plates and with drinking water flowing down through the drinking water outlet port into an external ocean floatable drinking water container, and
3. the desalination seawater container further has six container hexagon inner vertical walls, each with a vertical wall through hole pattern, each parallel to the external container hexagon vertical wall, thereby creating a vertical drinking water flow cavity between the parallel inner and external vertical hexagon walls for collecting the drinking water after passing through the Reverse Osmosis filters and flowing downwards through drinking water bottom flow cavity towards the drinking water outlet port, and
4. a vertical cylindrical hollow guide pole bolted to the container bottom inner plate with a pole lateral through hole close to its top and a connecting flow center hole into the drinking water bottom cavity, and
5. an external concentric hollow pole which is an extension part of the desalination moving actuator slides smoothly at controlled tight clearance over the cylindrical hollow guide pole, and
6. The axial up and down movement of the desalination moving actuator is limited by an actuator upper mechanical stop and actuator lower mechanical stop that is controlled by the length of the vertical hollow guide pole and the external concentric pole, and
7. A helical compression spring guided radially by the outer diameter of the vertical cylindrical hollow guide pole and guided axially by the container bottom inner plate applies an upward force on the desalination moving actuator's external concentric pole, pushing it up to the upper mechanical stop, and
8. the Desalination RO filter element comprises
a. Reverse Osmosis circular membrane of 2″ diameter
b. RO Membrane holder
c. RO Membrane end holder
d. RO Membrane holder bottom support
e. RO Filter plate support, and
9. the desalination bottom RO filter plate assembly with multiple embedded RO filter elements is bolted to the container bottom inner plate, thereby the seawater in the container forced down by the desalination moving actuator applies a high water pressure of 800-1000 psig on the embedded RO filter elements of the bottom desalination RO filter plate assembly for the reverse osmosis process, pushing drinking water molecules through the desalination bottom filter assembly plate and then through the inner bottom through hole pattern holes and then into the bottom drinking water flow cavity flowing toward the drinking water outlet port, and
10. The desalination vertical hexagon RO filter plate assembly with multiple embedded RO filter elements is bolted to the container vertical hexagon inner plate, thereby the seawater in the container forced down by the desalination moving actuator applies a high water pressure of 800-1000 psig on the embedded RO filter elements of the desalination vertical hexagon RO filter plate assembly for the reverse osmosis process, pushing drinking water molecules through the desalination vertical hexagon filter assembly plate and then through the inner vertical hexagon through hole pattern holes and then into the bottom drinking water flow cavity flowing toward the drinking water outlet port, and
F. the desalination moving actuator comprises
1. the desalination moving actuator cycles up under seawater pressure force in the seawater container and the upward pressure force of the helical compression spring force, and
2. the desalination moving actuator cycles down under the downward force of the high air pressure top dome bellows actuator when high-pressure air in the dome bellows actuator has axial flexible bellow which allows axial travel of the actuator, and
3. a desalination moving actuator with a moving actuator bottom plate with through hole pattern and an upper parallel plate thereby creating a moving container upper drinking water flow cavity for collecting the drinking water after passing through the Reverse Osmosis filter, and
4. the moving actuator desalination RO filter assembly plate with multiple embedded reverse osmosis filter elements is bolted to said moving actuator bottom inner plate, thereby high seawater pressure in the seawater container applying high water pressure of 800-1000 psig on the top moving desalination filter assembly plate for the reverse osmosis process, pushing drinking water flows through the desalination upper filter assembly plate and then through the pattern through holes and then into the upper drinking water flow cavity, and then through the pole lateral through the hole and then flow through the pole flow connecting center hole into the bottom drinking water flow cavity flowing toward the drinking water outlet port, and
5. A radial flexible rubber with fabric reinforcement moving actuator bellow type seal with axial extension capability bolted to the desalination moving actuator seal flange and to the desalination water container seal flange, thereby the bellows extends axially during travel of the desalination moving actuator, keeping the sealing of the seawater container seawater under pressure in the desalination seawater container and prevents external seawater leakage upwards out of the desalination seawater container, and
G. the top dome with top dome radial flange bolted to the desalination seawater container radial flange, comprises;
4. a flexible rubber with fabric reinforcement top dome bellow actuator with axial extension capability bolted and sealed to the desalination moving actuator top flange and to the top dome upper flange and pushing the desalination moving actuator down when the high-pressure air pressurizes inside the top dome bellows actuator, therefore overcoming the force applied to the desalination moving actuator by seawater pressure in said desalination seawater container and by the helical compression spring, and
5. top dome bellow air inlet port connects high-pressure air from the desalination air tank into the top dome air bellow actuator, thereby filling the actuator with compressed air and pushing the desalination moving actuator downward against water pressure in the desalination seawater tank and against compression spring upward force, and
6. top dome bellow air outlet port connects the top dome air bellow actuator to the top tower secondary water tank air inlet port, thereby pressurizing the secondary water tank top air bladder against the secondary water tank water bladder and squeezing water under pressure into the inlet of desalination seawater container inlet port, and
H. the top dome Inlet port air solenoid valve assembly with one-way flow comprising a high-pressure air solenoid operated by DC electronic controller voltage, with the solenoid assembly inlet port connected to the tower pressurized air tank, and with the solenoid valve assembly outlet port connected high-pressure air to the top dome bellows actuator inlet port, thereby increasing the air pressure in the top dome bellows bladder, pushing said desalination moving actuator downwards to the lower mechanical stop, and
J. the top dome outlet port air solenoid valve assembly with one-way flow comprising a high-pressure air solenoid operated by DC electronic controller voltage, with the solenoid assembly inlet port connected to the air outlet port of the top dome connects high-pressure air from the top dome bellows actuator outlet port into the secondary water tank bladder air actuator outlet port, thereby applying pressure force on the water-filled bladder and increasing water pressure in the bladder to squeeze water flow into said desalination seawater container, and
K. the desalination seawater container Inlet port seawater solenoid valve assembly with a one-way flow comprising a solenoid operated by DC electronic controller voltage with solenoid assembly inlet port connected to the secondary water tank water bladder outlet port, and the solenoid outlet port is connected to the desalination seawater container inlet port, thereby filling the desalination seawater container with pressurized seawater, and
L. the desalination seawater container outlet port solenoid seawater valve assembly with a one-way flow comprising a solenoid operated by DC electronic controller voltage with solenoid valve assembly inlet port connected to desalination seawater container outlet port and the solenoid valve assembly outlet port is connected to the ocean seawater return pipe, thereby removing the unused 70% of the seawater and dumping them back to the ocean,
M. the drinking water outlet port solenoid valve assembly with one-way flow comprising a solenoid operated by DC electronic controller voltage with a solenoid valve assembly inlet port connected to the desalination seawater container drinking water outlet port and with the solenoid valve assembly outlet port connected to the drinking water tank that is floatable in the ocean seawater, and
N. the desalination seawater container pressure sensor with the pressure sensing probe is located within the desalination seawater container and provides a linear voltage output proportional to said water pressure to the DC electronic controller. Thereby when pressure is below 1000 psig, said top dome air inlet solenoid valve assembly is DC voltage-activated, while when the pressure increase above 1000 psig, said top dome air inlet solenoid valve assembly is deactivated, and
O. a lower mechanical stop magnetic position switch is located outside the desalination seawater container's external hexagonal wall. In addition, a magnet is attached to said desalination moving actuator at lower and upper mechanical stop locations, and
P. a pressure relief valve at the outlet of the secondary water tank air bladder actuator outlet port.
